(19) United States
(12) Patent Application Publication
(10) Pub. No.: US 2025/0039649 A1
(43) Pub. Date: Jan. 30, 2025

(54) MULTIPLE COMMUNICATION PROTOCOL SENSOR

(71) Applicant: Ademco Inc., Golden Valley, MN (US)

(72) Inventors: Mark O'Keefe, San Diego, CA (US); Kenneth Eskildsen, Great Neck, NY (US); Prabakaran Murugan, Karnataka (IN)

(73) Assignee: Ademco Inc., Golden Valley, MN (US)

(21) Appl. No.: 18/717,148

(22) PCT Filed: Dec. 1, 2022
(86) PCT No.: PCT/US2022/080752

§ 371 Date: Jun. 6, 2024

Related U.S. Application Data
(60) Provisional application No. 63/286,622, filed on Dec. 7, 2021.

(51) Int. Cl. H04W 4/38; H04L 69/18

(52) U.S. Cl. CPC H04W 4/38; H04L 69/18

(57) ABSTRACT

A sensor device includes a programmable processor, a sensor component in communication with the programmable processor, a transmitter in communication with the programmable processor, and a non-transitory computer-readable storage article in communication with the processor. The non-transitory computer-readable storage article includes a first communication protocol computer-executable instructions that, when executed by the programmable processor, cause the programmable processor to transmit data, via the transmitter, according to a first communication protocol. And, the non-transitory computer-readable storage article includes a second communication protocol computer-executable instructions that, when executed by the programmable processor, cause the programmable processor to transmit data, via the transmitter, according to a second communication protocol. The second communication protocol is different than the first communication protocol. When storing the first and second communication protocol computer-executable instructions, the storage article can lack additional memory capacity to store a firmware download.

### RELATED APPLICATIONS

This application claims priority to U.S. Provisional Patent Application No. 63/286,622, filed on Dec. 7, 2021, the contents of which are hereby incorporated by reference.

### TECHNICAL FIELD

This disclosure relates generally to sensor devices and related systems and methods, for instance, sensor devices configured for use in home automation, comfort, and security system networks.

### BACKGROUND

A home network may use a wireless network communication protocol to connect sensor devices within the home. For example, a hub device may use IEEE 802.15.4 to connect over one hundred sensor devices in a home to the hub device. The hub device may then collect sensor data collected by the sensor devices in the home. For instance, the hub device may collect security, comfort (e.g., temperature readings), and/or home automation sensor readings and output the security, comfort, and/or home automation sensor readings to another device in the home network or, in some cases, to a remote server.

The wireless network communication protocol can facilitate communication of data between one or more sensor devices and/or the hub device over the network. However, to facilitate communication of data between one or more sensor devices and/or the hub device over the network, typically each of the sensor devices in the network, along with the hub device, need to utilize a common wireless communication protocol. Thus, the use of a sensor device configured for communication via a single, first type of wireless network communication protocol can be confined to only those home networks using that single, first type of wireless network communication protocol. This, in turn, can limit the types of applications in which the sensor device can be deployed.

### SUMMARY

In general, this disclosure relates to devices, systems, and methods for wirelessly connecting devices using a particular communication protocol selected from two or more communication protocols. Embodiments include a sensor device that stores at least two different types of communication protocols such that one particular stored communication protocol can be selected for data communication over the network when the sensor device is installed in the network. This can provide a sensor device with enhanced versatility in terms of the networks within which the sensor device can be deployed.

As wireless networks initially developed, network communication protocols were relatively basic. Because these prior communication protocols were relatively basic, a device could in theory store two communication protocols at a storage component at the device given the relatively low amount of memory capacity needed for storing these prior, basic communication protocols. However, as wireless networks have further developed, the volume and complexity of data transmission between devices has increased such that most device storage components have insufficient memory capacity to store two communication protocols. As such, typical current devices generally store a first communication protocol and reserve remaining memory capacity for any firmware downloads, for instance a firmware download of a second, different communication protocol, or a firmware download for feature enhancement(s) and/or bug fixes, such that this reserved memory capacity lies in wait for the firmware download to arrive. When the firmware download arrives, such as the second, different communication protocol, it can be stored in the reserved memory capacity and the device can switch from executing the first communication protocol to executing the second, newly downloaded communication protocol. The memory capacity occupied by the first communication protocol can then be overwritten with any subsequent firmware download.

Embodiments disclosed herein can utilize a substantial extent of the memory capacity at a sensor device at the time the sensor device is manufactured such that any reserved memory capacity is minimized or eliminated. In particular, sensor device embodiments disclosed herein can store both a first communication protocol computer-executable instructions and a second, different communication protocol computer-executable instructions at the time of manufacture of the sensor device such that the first and second communication protocol computer-executable instructions occupy a substantial extent of the memory capacity at a sensor device at the time the sensor device is manufactured, resulting in minimizing or eliminating any reserved memory capacity at the sensor device. Then, once the sensor device in installed in a network and one of the first and second communication protocol computer-executable instructions is selected for data communication over the network, the other, non-selected communication protocol computer-executable instructions can be erased from the memory component at the sensor device (e.g., overwritten when a firmware download is received at the sensor device).

In this way, embodiments disclosed herein can be useful in providing sensor devices with enhanced versatility in terms of the networks within which the sensor device can be deployed by facilitating use of the sensor device in various networks that use different types of communication protocols. And, yet at the same time, such embodiments can efficiently utilize memory capacity throughout the life of the sensor device, including at the sensor device before sensor device installation—by providing multiple communication protocols stored at the sensor device and thus increasing the application versatility of the sensor device and reducing sensor device cost—and at the sensor device after sensor device installation—by removing a non-selected communication protocol to create memory capacity for any future firmware download.

One embodiment includes a sensor device. This sensor device embodiment includes a programmable processor, a sensor component in communication with the programmable processor, a transmitter in communication with the programmable processor, and a non-transitory computer-readable storage article in communication with the processor. The sensor component is configured to detect at least one ambient condition. The transmitter is configured to transmit data relating to the at least one ambient condition. The non-transitory computer-readable storage article includes a first communication protocol computer-executable instructions that, when executed by the programmable processor, cause the programmable processor to transmit data, via the transmitter, according to a first communication protocol. And, the non-transitory computer-readable storage article includes a second communication protocol computer-executable instructions that, when executed by the programmable processor, cause the programmable processor to transmit data, via the transmitter, according to a second communication protocol. The second communication protocol is different than the first communication protocol. The first communication protocol computer-executable instructions and the second communication protocol computer-executable instructions occupy an amount of memory capacity of the non-transitory computer-readable storage article such that the non-transitory computer-readable storage article lacks additional memory capacity to store a firmware download in addition to the first communication protocol computer-executable instructions and the second communication protocol computer-executable instructions.

In a further embodiment of the sensor device, the first communication protocol and the second communication protocol utilize a same frequency band. For instance, the same frequency band an be 2.4 GHz.

In a further embodiment of the sensor device, only one of the first communication protocol and the second communication protocol utilizes time divisional multiple access (TDMA).

In a further embodiment of the sensor device, the programmable processor is configured to select one of the first communication protocol computer-executable instructions and the second communication protocol computer-executable instructions for use in transmitting data relating to the at least one ambient condition. For example, after the programmable processor has selected one of the first communication protocol computer-executable instructions and the second communication protocol computer-executable instructions for use in transmitting data relating to the at least one ambient condition, the sensor device can be configured to overwrite the other of the first communication protocol computer-executable instructions and the second communication protocol computer-executable instructions in the non-transitory computer-readable storage article with a firmware download received at the sensor device. As another example, the sensor device can further include a protocol selection input mechanism that is configured to receive user input selecting one of the first communication protocol and the second communication protocol for use transmitting data. The protocol selection input mechanism can be in communication with the programmable processor. As a further example, the programmable processor can be configured to select one of the first communication protocol computer-executable instructions and the second communication protocol computer-executable instructions for use in transmitting data based on a signal received at the sensor device. For instance, the signal received at the sensor device can include information relating to a type of protocol utilized in a network, and the programmable processor can be configured to select one of the first communication protocol computer-executable instructions and the second communication protocol computer-executable instructions for use in transmitting data based on the type of protocol utilized in the network.

In a further embodiment of the sensor device, the non-transitory computer-readable storage article includes the first communication protocol computer-executable instructions and the second communication protocol computer-executable instructions at a time when the sensor device is manufactured.

In a further embodiment of the sensor device, the non-transitory computer-readable storage article is a single memory component, and the single memory component includes each of the first communication protocol computer-executable instructions and the second communication protocol computer-executable instructions.

In a further embodiment of the sensor device, the sensor component is selected from the group consisting of: a motion detector, a glass break detector, a door open detector, a window open detector, a smoke detector, and a gas detector.

Another embodiment includes a method. This method embodiment includes the step of removing a sensor device from a package. When the sensor device is in the package, the sensor device includes a programmable processor, a sensor component in communication with the programmable processor, a transmitter in communication with the programmable processor, and a non-transitory computer-readable storage article in communication with the processor. The sensor component is configured to detect at least one ambient condition. The transmitter is configured to transmit data relating to the at least one ambient condition. When the sensor device is in the package, the non-transitory computer-readable storage article includes a first communication protocol computer-executable instructions that, when executed by the programmable processor, cause the programmable processor to transmit data, via the transmitter, according to a first communication protocol. And, when the sensor device is in the package, the non-transitory computer-readable storage article includes a second communication protocol computer-executable instructions that, when executed by the programmable processor, cause the programmable processor to transmit data, via the transmitter, according to a second communication protocol. The second communication protocol is different than the first communication protocol. The method also includes the steps of installing the sensor device in a premise network, selecting, from the non-transitory computer-readable storage article at the sensor device, one of the first communication protocol computer-executable instructions and the second communication protocol computer-executable instructions, and using the selected one of the first communication protocol computer-executable instructions and the second communication protocol computer-executable instructions to transmit data, via the premise network, relating to the at least one ambient condition.

In a further embodiment of the method, when the sensor device is in the package, the first communication protocol computer-executable instructions and the second communication protocol computer-executable instructions occupy an amount of memory capacity of the non-transitory computer-readable storage article such that the non-transitory computer-readable storage article lacks additional memory capacity to store a firmware download in addition to the first communication protocol computer-executable instructions and the second communication protocol computer-executable instructions.

In a further embodiment of the method, the first communication protocol and the second communication protocol utilize a same frequency band. For instance, the same frequency band can be 2.4 GHz.

In a further embodiment of the method, only one of the first communication protocol and the second communication protocol utilizes time divisional multiple access (TDMA).

In a further embodiment of the method, the method additionally includes the step of, after selecting one of the first communication protocol computer-executable instructions and the second communication protocol computer-executable instructions, receiving, at the sensor device, a firmware download and overwriting the other of the first communication protocol computer-executable instructions and the second communication protocol computer-executable instructions in the non-transitory computer-readable storage article.

In a further embodiment of the method, the non-transitory computer-readable storage article is a single memory component, and the single memory component includes each of the first communication protocol computer-executable instructions and the second communication protocol computer-executable instructions.

In a further embodiment of the method, the method additionally includes the step of receiving, via the premise network at the sensor device from a hub device, a signal including information relating to a type of protocol utilized in the premise network. The one of the first communication protocol computer-executable instructions and the second communication protocol computer-executable instructions can be selected after installing the sensor device in the premise network and based on the type of protocol utilized in the premise network.

The details of one or more examples of the disclosure are set forth in the accompanying drawings and the description below. Other features, objects, and advantages of the disclosure will be apparent from the description and drawings, and from the claims.

### BRIEF DESCRIPTION OF DRAWINGS

The following drawings are illustrative of particular examples of the present invention and therefore do not limit the scope of the invention. The drawings are not necessarily to scale, though embodiments can include the scale illustrated, and are intended for use in conjunction with the explanations in the following detailed description wherein like reference characters denote like elements. Examples of the present invention will hereinafter be described in conjunction with the appended drawings.

FIG. 1 is a conceptual block diagram illustrating an exemplary embodiment of a home network, in accordance with some examples of this disclosure.

FIG. 2 is a conceptual block diagram illustrating an exemplary embodiment of a hub device in greater detail, in accordance with some examples of this disclosure.

FIG. 3 is a conceptual block diagram illustrating an exemplary embodiment of a sensor device in greater detail, in accordance with some examples of this disclosure.

FIG. 4 is a conceptual block diagram of an exemplary embodiment of slots of a single superframe of a first type of communication protocol, in accordance with some examples of this disclosure.

FIG. 5 is a flow diagram illustrating an exemplary embodiment of a method, in accordance with some examples of this disclosure.

### DETAILED DESCRIPTION

The following detailed description is exemplary in nature and is not intended to limit the scope, applicability, or configuration of the invention in any way. Rather, the following description provides some practical illustrations for implementing examples of the present invention. Those skilled in the art will recognize that many of the noted examples have a variety of suitable alternatives.

Modern residential buildings or other buildings may include a central “hub” device configured to manage one or more systems within the building, such as monitoring systems, comfort systems, security systems, and/or home automation systems. The hub device can be in wireless communication with a number of sensor devices placed throughout the building. For example, the hub device may wirelessly receive sensor data from any number of different sensor devices, such as motion sensors, air quality and/or temperature sensors, infrared sensors, door and/or window contact sensors, switches, and/or other sensor devices. Additionally, the hub device may wirelessly transmit commands or instructions to one or more controllable sensor devices. For example, the hub device may instruct a thermostat to adjust a temperature within the building, or in another example, may command a damper to open or close an air vent.

Smart home devices can utilize different wireless communication protocols to address the needs to the smart home. There are standards-based protocols (Wi-Fi™, Zigbee™, Thread™, Zwave™, BLUETOOTH, DECT™, MATTER™, etc.) and proprietary, manufacturer specific protocols (time-division multiple access (TDMA)). Different wireless communication protocols can be different in different applications since certain types of protocols are better suited for particular applications. For example, proprietary, manufacturer specific protocols (e.g., time-division multiple access (TDMA)) can be useful in applications utilizing sensor devices from that same manufacturer and, thereby, the proprietary, manufacturer specific protocol can optimize network communication performance. While standards-based protocols (e.g., MATTER™) can be useful in expanding network communication to be executed across sensor devices from different manufactures.

Smart home systems may include one network, or a collection of different networks, that operate at a common frequency suitable for home networks. For example, two or more different communication protocols (e.g., TDMA and non-TDMA, such as MATTER™) can each operate at a 2.4 GHz frequency band. A hub device may allocate each sensor device to a time slot, also referred to herein as simply “slot,” of the superframe (e.g., during a registration process). In this example, the hub device may output the superframe using a beacon that specifies a beginning of the superframe. Sensor devices of the network can synchronize to the beacon and output data at the 2.4 GHz frequency according to the allocated slots (e.g., relative to the beacon) of the superframe.

In accordance with the features of this disclosure, a sensor device can be configured to store two or more different communication protocols prior to the sensor device being installed in a network (e.g., at a time when the sensor device is manufactured). Such sensor device embodiments can be configured to utilize a substantial extent of the memory capacity at a sensor device at the time the sensor device is manufactured such that any reserved memory capacity is minimized or eliminated. In particular, sensor device embodiments disclosed herein can store both a first communication protocol computer-executable instructions and a second, different communication protocol computer-executable instructions at the time of manufacture of the sensor device such that the first and second communication protocol computer-executable instructions occupy a substantial extent of the memory capacity at a sensor device at the time the sensor device is manufactured, resulting in minimizing or eliminating any reserved memory capacity at the sensor device. Then, once the sensor device in installed in a network and one of the first and second communication protocol computer-executable instructions is selected for data communication over the network, the other, non-selected communication protocol computer-executable instructions can be erased from the memory component at the sensor device (e.g., overwritten when a firmware download is received at the sensor device).

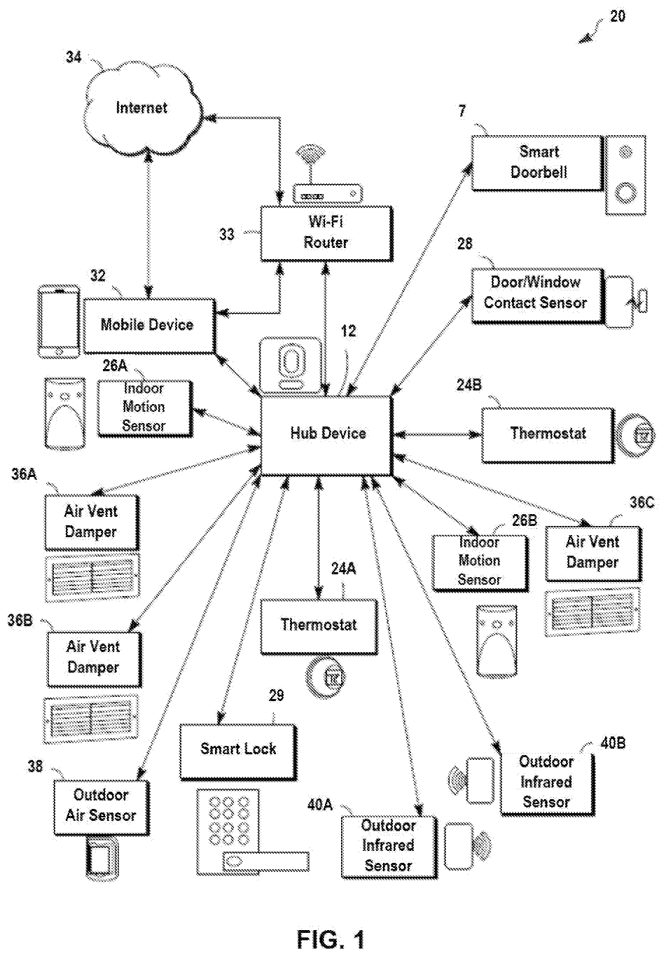

FIG. 1 is a conceptual block diagram illustrating an exemplary embodiment of a home network 20, in accordance with examples of this disclosure. Various devices, including various types of sensor devices, can be deployed in the network 20. For example, in the network 20, various devices, including various sensor devices, can be in communication with a hub device 12. In some such embodiments, these devices in the network 20 can be in data communication (e.g., two-way data communication) with the hub device 12 using a superframe. In some examples, the superframe can be a proprietary, manufacturer specific protocol, such a time divisional multiple access (TDMA) superframe, or a standards-based protocol, such as a non-TDMA superframe, for instance a MATTER™ superframe. Network 20 may be installed within a building and the surrounding premises (collectively, “premise”).

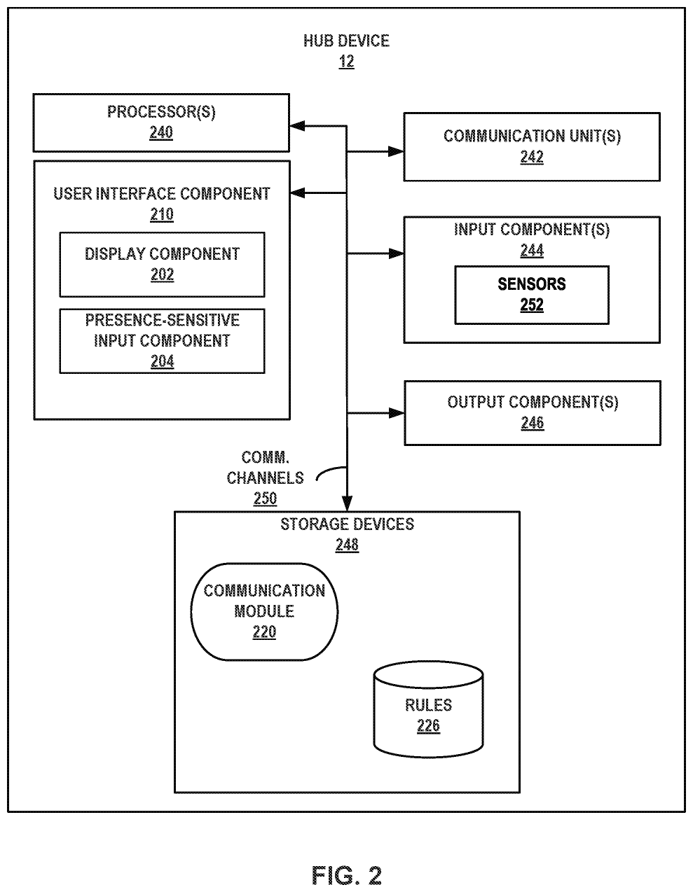

Hub device 12 may include a computing device configured to operate one or more systems within a building, such as comfort, security, safety, and/or home automation systems. For example, as described further below in reference to FIG. 2, hub device 12 can include processing circuitry 240 configured to receive data, such as data received from one or more sensor devices and/or from user input, and process the data in order to automate one or more systems within a building. For example, hub device 12 may automate, control, or otherwise manage systems including heating and cooling, ventilation, illumination, or authorized access to individual rooms or other regions, as non-limiting examples. For example, hub device 12 may include a “Life and Property Safety Hub®” of Resideo Technologies, Inc. R, of Austin, Texas. Hub device 12 may include a wired connection to an electric power grid, but in some examples may include an internal power source, such as a battery, supercapacitor, or another internal power source.

Devices on the network 20, including sensor devices, can be configured to enroll with hub device 12. For example, a sensor device can be configured to exchange sensor data with hub device 12 and/or be controlled by hub device 12. Sensor devices may be configured to collect or generate sensor data and transmit the sensor data to hub device 12 for processing. In some examples, sensor devices can include a controllable device. A controllable device may be configured to perform a specified function when the controllable device receives instructions (e.g., a command or other programming) to perform the function from hub device 12. Examples of different types of sensor devices that can be included in the network 20 are described below. Sensor devices can include either a wired connection to an electric power grid or an internal power source, such as a battery, supercapacitor, or another internal power source. Although FIG. 1 shows hub device 12 as directly connected to the various devices in the network 20, in some examples, network 20 can include one or more repeater nodes that are each configured to act as an intermediary or “repeater” device.

As shown for the illustrated embodiment of the network 20 at FIG. 1, in addition to the hub device 12, the network system 20 can include various devices, including various types of sensor device. Exemplary types of sensor devices that can deployed in the network system include thermostats 24A, 24B (collectively, thermostats 24), indoor motion sensor 26A and outdoor motion sensor 26B (collectively, motion sensors 26), door/window contact sensor 28, air vent damper 36A, 36B, 36C (collectively, air vent dampers 36), smart doorbell 37, outdoor air sensor 38, outdoor infrared sensor 40A, indoor infrared sensor 40B (collectively, infrared sensors 40). In addition to the sensor devices, the network system can include devices such as router 33 and mobile device 32. Hub device 12 and one or more of the devices in the networked system 20 can communicate using a first communication protocol computer-executable instructions (e.g., a proprietary, manufacturer specific protocol, such as TDMA) or a second, different communication protocol computer-executable instructions (e.g., a standards-based protocol, such as a non-TDMA protocol, for instance MATTER™ protocol) stored at each device in the network 20. In some examples, the first and second different communication protocol computer-executable instructions stored at each device can communicate using a same frequency band, such as 2.4 GHz.

Hub device 12 can be in wireless data communication with thermostats 24, motion sensors 26, door/window contact sensor 28, air vent dampers 36, smart doorbell 37, outdoor air sensor 38, and infrared sensors 40. Each of thermostats 24, motion sensors 26, door/window contact sensor 28, air vent dampers 36, smart doorbell 37, outdoor air sensor 38, and infrared sensors 40 may include either a sensor device (e.g., a device configured to collect and/or generate sensor data), a controllable device, or both, as described herein. For example, thermostats 24 may include comfort devices having sensors, such as a thermometer configured to measure an ambient air temperature. In some examples, air vent dampers 36 may include devices located within an air vent or air duct, configured to either open or close the shutters of an air vent in response to receiving instructions from hub device 12.

Thermostats 24 may be configured to wirelessly transmit the temperature (e.g., sensor data) directly to hub device 12. Additionally, thermostats 24 may include controllable devices, in that they may activate or deactivate a heating, cooling, or ventilation system in response to receiving instructions from hub device 12. For example, thermostat 24A may collect temperature data and transmit the data to hub device 12. Hub device 12, in response to receiving the temperature data, may determine that a respective room is either too hot or too cold based on the temperature data, and transmit a command to thermostat 24A to activate a heating or cooling system as appropriate. In this example, each of thermostats 24 may include both sensor devices and controllable devices within a single distinct unit.

Indoor and outdoor motion sensors 26 may include security devices configured to detect the presence of a nearby mobile object based on detecting a signal, such as an electromagnetic signal, an acoustic signal, a magnetic signal, a vibration, or other signal. The detected signal may or may not be a reflection of a signal transmitted by the same device. In response to detecting the respective signal, motion sensors 26 may generate sensor data indicating the presence of an object, and wirelessly transmit the sensor data to hub device 12. Hub device 12 may be configured to perform an action in response to receiving the sensor data, such as outputting an alert, such as a notification to mobile device 32, or by outputting a command for the respective motion sensor 26 to output an audible or visual alert. In this example, each of motion sensors 26 may include both sensor devices and controllable devices within a single unit.

Door and/or window contact sensor 28 may include a security device configured to detect the opening of a door or window on which the door and/or window contact sensor 28 is installed. For example, contact sensor 28 may include a first component installed on a door or window; and a second component installed on a frame of the respective door or window. When the first component moves toward, past, or away from the second component, the contact sensor 28 may be configured to generate sensor data indicating the motion of the door or window; and wirelessly transmit the sensor data to hub device 12. In response to receiving the sensor data, hub device may be configured to perform an action such as outputting an alert, such as a notification to mobile device 32, or by outputting a command for the respective contact sensor 28 to output an audible or visual alert. In this example, contact sensor 28 may include a sensor devices and a controllable devices within a single unit.

Air vent dampers 36 may be configured to regulate a flow of air inside of a duct. For example, thermostats 24 may generate a control signal to close air vent damper 36A (e.g., when the room is not occupied). In this example, in response to the control signal, air vent damper 36 may close to prevent air from flowing from air vent damper 36A. In some examples, air vent dampers 36 may send sensor data indicating a state (e.g., open or closed) of the respective air vent damper. For instance, air vent damper 36 may output, to thermostats 24 an indication that air vent damper 36 is in an open state.

Smart doorbell 37 may be configured to provide notifications to hub device 12. For example, smart doorbell 37 may be configured to provide a notification (e.g., message) when a button (e.g., doorbell) of smart doorbell 37 is activated. In some examples, smart doorbell 37 may include motion sensor circuitry configured to generate a notification in response to motion detected near smart doorbell 37. In some examples, smart doorbell 37 may be configured to generate video content in response to motion detected near smart doorbell 37. In some examples, smart doorbell 37 may be configured to generate audio content in response to motion detected near smart doorbell 37. For instance, in response to motion detected near smart doorbell 37, smart doorbell 37 may generate video content using a camera and/or audio content using a microphone. In this instance, smart doorbell 37 may output the video content and audio content to hub device 12, which may forward the video content and/or audio content to mobile device 32.

Outdoor air sensor 38 may be configured to generate sensor data indicating, for example, a temperature, humidity, and/or quality (e.g., carbon monoxide, particulate matter, or other hazards) of the surrounding air. In some examples, outdoor air sensor 38 may wireless transmit the sensor data to hub device 12. For instance, outdoor air sensor 38 may periodically output a current or average temperature to thermostats 24 via hub device 12.

Outdoor passive infrared sensors 40 may include security devices configured to detect the presence of a nearby object, such as a person, based on detecting infrared wavelength electromagnetic waves emitted by the object. In response to detecting the infrared waves, passive infrared sensors 40 may generate sensor data indicating the presence of the object, and wirelessly transmit the sensor data to hub device 12. Hub device 12 may be configured to perform an action in response to receiving the sensor data, such as outputting an alert, such as a notification to mobile device 32, or by outputting a command for the respective passive infrared sensor 40 to output an audible or visual alert.

Network 20 may include various devices, including, for example, a security device, a water heater, a water flow controller, a garage door controller, or other devices. For example, network 20 may include one or more of: a door contact sensor, a motion passive infrared (PIR) sensor, a mini contact sensor, a key fob, a smoke detector, a glass break detector, a siren, a combined smoke detector and Carbon monoxide (CO) detector, an indoor siren, a flood sensor, a shock sensor, an outdoor siren, a CO detector, a wearable medical pendant, a wearable panic device, an occupancy sensor, a keypad, and/or other devices.

In accordance with the techniques of the disclosure, hub device 12 and each of thermostats 24, motion sensors 26, door/window contact sensor 28, air vent dampers 36, smart doorbell 37, outdoor air sensor 38, and infrared sensors 40 may be configured to operate using a superframe of a selected communication protocol to transmit data. Initially, hub device 12 may be configured to output a superframe to each of thermostats 24, motion sensors 26, door/window contact sensor 28, air vent dampers 36, smart doorbell 37, outdoor air sensor 38, and infrared sensors 40 according to a regular, pre-defined, periodic schedule.

FIG. 2 is a block diagram illustrating an exemplary embodiment of the hub device 12, in accordance with one or more aspects of the techniques described in this disclosure. FIG. 2 illustrates only one particular example of hub device 12, and many other examples of hub device 12 may be used in other instances and may include a subset of the components included in example hub device 12 or may include additional components not shown in FIG. 2.

As shown in the example of FIG. 2, hub device 12 includes user interface component (UIC) 210, processing circuitry, such as one or more programmable processors 240, one or more communication units 242, one or more input components 244, one or more output components 246, and one or more storage components 248. UIC 210 includes display component 202 and presence-sensitive input component 204. Storage components 248 of hub device 12 include communication module 220 and rules data store 226.

One or more processors 240 may implement functionality and/or execute instructions, including selection of one of a first communication protocol computer-executable instructions and a second, different communication protocol computer-executable instructions, stored at hub device 12 to facilitate data communication with one or more devices in the network. Examples of processors 240 include application processors, display controllers, auxiliary processors, one or more sensor hubs, and any other hardware configure to function as a processor, a processing unit, or a processing device. Module 220 may be operable by processors 240 to perform various actions, operations, or functions of hub device 12. For example, processors 240 of hub device 12 may retrieve and execute instructions stored by storage components 248 that cause processors 240 to perform the operations described with respect to module 220.

Communication module 220 may execute locally (e.g., at processors 240) to provide functions associated with communicating, using communication units 242, with various sensor devices. In some examples, communication module 220 may act as an interface to a remote service accessible to hub device 12. For example, UI module 220 may be an interface or application programming interface (API) to a remote server that facilitates communication with the various sensor devices. For instance, the storage device 248, at the communication module 220, can store both a first communication protocol computer-executable instructions (e.g., a proprietary, manufacturer specific protocol, such as TDMA) and a second, different communication protocol computer-executable instructions (e.g., a standards-based protocol, such as a non-TDMA protocol, for instance MATTER™ protocol). The processor 240 can then execute a selected one of the first communication protocol computer-executable instructions and the second, different communication protocol computer-executable instructions to carry out data communication with one or more sensor devices in the network. And, storage components 248 may include a memory configured to store data or other information associated with module 220 and rules data store 226.

Communication channels 250 may interconnect each of the components 240, 242, 244, 246, and 248 for inter-component communications (physically; communicatively, and/or operatively). In some examples, communication channels 250 may include a system bus, a network connection, an inter-process communication data structure, or any other method for communicating data.

One or more communication units 242 of hub device 12 may communicate with external devices via one or more wired and/or wireless networks by transmitting and/or receiving network signals on one or more networks. Examples of communication units 242 include a network interface card (e.g. such as an Ethernet card), an optical transceiver, a radio frequency transceiver, a GPS receiver, or any other type of device that can send and/or receive information. Other examples of communication units 242 may include short wave radios, cellular data radios, wireless network radios, as well as universal serial bus (USB) controllers.

One or more input components 244 of hub device 12 may receive input. Examples of input are tactile, audio, and video input. Input components 244 of hub device 12, in one example, includes a presence-sensitive input device (e.g., a touch sensitive screen, a PSD), mouse, keyboard, voice responsive system, camera, microphone or any other type of device for detecting input from a human or machine. In some examples, input components 244 may include one or more sensor components (e.g., sensors 252), including both internal sensors and connections to external sensors.

UIC 210 of hub device 12 may include display component 202 and presence-sensitive input component 204. Display component 202 may be a screen, such as any of the displays or systems described with respect to output components 246, at which information (e.g., a visual indication) is displayed by UIC 210 while presence-sensitive input component 204 may detect an object at and/or near display component 202.

While illustrated as an internal component of hub device 12, UIC 210 may also represent an external component that shares a data path with hub device 12 for transmitting and/or receiving input and output. For instance, in one example, UIC 210 represents a built-in component of hub device 12 located within and physically connected to the external packaging of hub device 12 (e.g., a screen on a mobile phone). In another example, UIC 210 represents an external component of hub device 12 located outside and physically separated from the packaging or housing of hub device 12 (e.g., a monitor, a projector, etc. that shares a wired and/or wireless data path with hub device 12).

Thus, the storage device 248 at hub device 12 can be configured to store data, as well as instructions that, when executed by processing circuitry 240, cause hub device 12 to perform one or more techniques in accordance with this disclosure. This can include, as noted, storing both a first communication protocol computer-executable instructions (e.g., a proprietary, manufacturer specific protocol, such as TDMA) and a second, different communication protocol computer-executable instructions (e.g., a standards-based protocol, such as a non-TDMA protocol, for instance MATTER™ protocol). The processor 240 can then execute a selected one of the first communication protocol computer-executable instructions and the second, different communication protocol computer-executable instructions to carry out data communication with one or more sensor devices in the network.

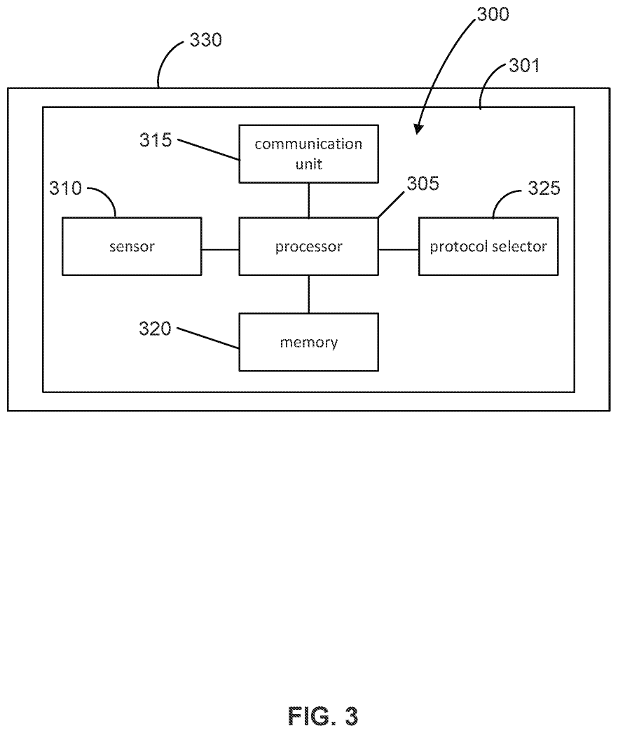

FIG. 3 illustrates a conceptual block diagram illustrating an exemplary embodiment of a sensor device 300 in greater detail, in accordance with some examples of this disclosure. The sensor device 300 can be any of the sensor devices disclosed elsewhere herein, including in reference to the network shown at FIG. 1. The sensor device 300 can be configured to store both a first communication protocol computer-executable instructions (e.g., a proprietary, manufacturer specific protocol, such as TDMA) and a second, different communication protocol computer-executable instructions (e.g., a standards-based protocol, such as a non-TDMA protocol, for instance MATTER™ protocol). For example, the sensor device 300 can store both the first and second communication protocol computer-executable instructions prior to the sensor device 300 being installed in the network. And, the sensor device 300 can be configured to select one of the first and second communication protocol computer-executable instructions for execution at the sensor device 300 to facilitate data communication at the sensor device 300 within the network (e.g., data communication to and/or from the hub device).

The sensor device 300 can include a housing 301, a programmable processor 305, at least one sensor component 310, a communication unit, such as a trans-mitter, 315, a non-transitory computer-readable storage article, such as a memory component, 320, and a protocol selector 325. Each of the programmable processor 305, the at least one sensor component 310, the communication unit, such as the transmitter, 315, the non-transitory computer-readable storage article, such as the memory component, 320, and the protocol selector 325 can be supported at the housing 301 of the sensor device 300.

The sensor component 310 can be configured to detect at least one condition, such as an ambient condition in the vicinity of the sensor component 310. The particular type of sensor component 310 can vary depending on the application of the sensor device 300. Examples of types of sensor components can include any one of those disclosed elsewhere herein, including in reference to the network of FIG. 1. As one specific example, the sensor component 310 can be selected from the group consisting of: a motion detector, a glass break detector, a door open detector, a window open detector, a smoke detector, and a gas detector. The sensor component 310 can be in communication with the programmable processor 305. Accordingly, the processor 305 can be configured to cause the sensor component 310 to turn on and check for a particular ambient condition.

The communication unit 315 can be configured to send and/or receive one or more signals from another device, such as the hub device. The communication unit 315 can include a transmitter and/or a receiver (e.g., the communication unit 315 can be a wireless transceiver). As such, as one example, the communication unit 315 can be configured to transmit data relating to the at least one ambient condition detected by the sensor component 310. The communication unit 315 can be in in communication with the programmable processor 305. Accordingly, the processor 305 can be configured to cause the communication unit 315 to send a signal to another device, such as the hub device, in the network.

The non-transitory computer-readable storage article, such as the memory component, 320 can be configured to store one or more communication protocols that can be executed by the processor 305 to cause the communication unit to communicate data according to a particular communication protocol. In particular, the non-transitory computer-readable storage article 320 can include both a first communication protocol computer-executable instructions (e.g., a proprietary, manufacturer specific protocol, such as TDMA) and a second, different communication protocol computer-executable instructions (e.g., a standards-based protocol, such as a non-TDMA protocol, for instance MATTER™ protocol). For example, the non-transitory computer-readable storage article 320 can store both the first and second communication protocol computer-executable instructions prior to the sensor device 300 being installed in the network. This could include the non-transitory computer-readable storage article 320 storing both the first and second communication protocol computer-executable instructions at the time the sensor device 300 is manufactured. The non-transitory computer-readable storage article 320 can be in communication with the processor 305. For instance, in one example, the non-transitory computer-readable storage article 320 can be integrated with the processor 305 as dedicated memory capacity at the processor 305 itself. In some cases, the non-transitory computer-readable storage article 320 can be a single memory component, and this single memory component can include each of the first communication protocol computer-executable instructions and the second communication protocol computer-executable instructions. When the first communication protocol computer-executable instructions are executed by the processor 305, the first communication protocol computer-executable instructions can cause the processor 305 to transmit data, via the communication unit 315, according to a first communication protocol. And, when the second communication protocol computer-executable instructions are executed by the processor 305, the second communication protocol computer-executable instructions can cause the processor 305 to transmit data, via the communication unit 315, according to a second communication protocol. The second communication protocol can be different than the first communication protocol.

As such, FIG. 3 shows the sensor device 300 enclosed within a package 330. When the sensor device 300 is enclosed within the package 330, the sensor device 300 can store, such as at the non-transitory computer-readable storage article 320, both the first communication protocol computer-executable instructions (e.g., a proprietary, manufacturer specific protocol, such as TDMA) and the second, different communication protocol computer-executable instructions (e.g., a standards-based protocol, such as a non-TDMA protocol, for instance MATTER™ protocol). The first and second different communication protocol computer-executable instructions stored at the sensor device 300 can utilize a substantial extent of the memory capacity at the sensor device 300 at the time the sensor device 300 is manufactured such that any reserved memory capacity at the sensor device 300 (e.g., at the non-transitory computer-readable storage article 320) is minimized or eliminated. In particular, the sensor device 300 can store both the first communication protocol computer-executable instructions and the second, different communication protocol computer-executable instructions at the time of manufacture of the sensor device 300 such that the first and second communication protocol computer-executable instructions occupy a substantial extent of the memory capacity at a sensor device 300 (e.g., at the non-transitory computer-readable storage article 320) at the time the sensor device 300 is manufactured, resulting in minimizing or eliminating any reserved memory capacity at the sensor device 300 (e.g., at the non-transitory computer-readable storage article 320). As one such example, the first communication protocol computer-executable instructions and the second communication protocol computer-executable instructions can occupy an amount of memory capacity of the non-transitory computer-readable storage article 320 such that the non-transitory computer-readable storage article 320 lacks additional memory capacity to store a firmware download (e.g., receivable at the sensor device 300 over the network when the sensor device 300 is installed within the network) in addition to the first communication protocol computer-executable instructions and the second communication protocol computer-executable instructions.

In some embodiments, both the first communication protocol and the second communication protocol can utilize a same frequency band for transmitting data from the sensor device 300 to another device in the network, such as the hub device. As one such example, both the first and second communication protocols can utilize a same frequency band of 2.4 GHz for transmitting data from the sensor device 300. In this particular 2.4 GHz example, one of the first and second protocol can be TDMA and the other of the first and second protocol can be a non-TDMA protocol (e.g., a standards-based protocol, such as MATTER™). Thus, in this particular 2.4 GHz example, only one of the first communication protocol and the second communication protocol utilizes TDMA. As another such example, both the first and second communication protocols can utilize a same frequency band of sub-1 GHz for transmitting data from the sensor device 300.

The sensor device 300 can be configured to select one of the first communication protocol computer-executable instructions and the second communication protocol computer-executable instructions for use in transmitting data relating to the at least one ambient condition detected by the sensor component 310. As noted, before the sensor device 300 is installed in the network, the sensor device 300 can store both of the first communication protocol computer-executable instructions and the second communication protocol computer-executable instructions. This can include the sensor device 300 storing both of the first communication protocol computer-executable instructions and the second communication protocol computer-executable instructions at the time of manufacture and when the sensor device 300 is enclosed within the package 330. Then, after the sensor device 300 is removed from the package 330, the sensor device 300 can be configured to select one of the first communication protocol computer-executable instructions and the second communication protocol computer-executable instructions for use in transmitting data relating to the at least one ambient condition detected by the sensor component 310. For example, the sensor device 300 can be configured to select one of the first communication protocol computer-executable instructions and the second communication protocol computer-executable instructions during or after installation of the sensor device 300 in the network.

For example, the processor 305 of the sensor device 300 can be configured to select one of the first communication protocol computer-executable instructions and the second communication protocol computer-executable instructions after the sensor device 300 is removed from the package 330 (e.g., during or after installation of the sensor device 300 in the network). After the processor 305 has selected one of the first communication protocol computer-executable instructions and the second communication protocol computer-executable instructions for use in transmitting data relating to the at least one ambient condition, the sensor device 300 can be configured to remove the other, non-selected of the first communication protocol computer-executable instructions and the second communication protocol computer-executable instructions from the non-transitory computer-readable storage article 320. For instance, after the processor 305 has selected one of the first communication protocol computer-executable instructions and the second communication protocol computer-executable instructions for use in transmitting data relating to the at least one ambient condition, the sensor device 300 can be configured to remove the other, non-selected of the first communication protocol computer-executable instructions and the second communication protocol computer-executable instructions from the non-transitory computer-readable storage article 320 by overwriting the other, non-selected of the first communication protocol computer-executable instructions and the second communication protocol computer-executable instructions in the non-transitory computer-readable storage article 320 with a data download (e.g., firmware download) received (e.g., received over the network) at the sensor device 300 when the sensor device 300 is installed in the network.

In one embodiment, the processor 305 can be configured to select one of the first communication protocol computer-executable instructions and the second communication protocol computer-executable instructions for use in transmitting data based on a signal received at the sensor device 300. For instance, the signal received at the sensor device 300 can include information relating to a type of protocol utilized in a network, such as a type of protocol utilized by the hub device. The processor 305 can then be configured to select one of the first communication protocol computer-executable instructions and the second communication protocol computer-executable instructions for use in transmitting data based on the type of protocol utilized in the network.

As one specific such example, once the sensor device 300 is installed in the network, the sensor device 300 can receive a beacon signal from the hub device. The processor 305 of the sensor device 300 can then process the received beacon signal and determine whether the received beacon signal corresponds to the first communication protocol or the second communication protocol. When the processor 305 determines that the received beacon signal corresponds to the first communication protocol, the processor 305 can select the first communication protocol computer-executable instructions, and when the processor 305 determines that the received beacon signal corresponds to the second communication protocol, the processor 305 can select the second communication protocol computer-executable instructions. In some cases, the processor 305 can pre-select one of the first or second communication protocol computer-executable instructions and if the processor 305 does not receive a beacon signal corresponding to the pre-selected first or second communication protocol computer-executable instructions for a preset period of time, the processor 305 can be configured to select the other, non-pre-selected one of the first or second communication protocol computer-executable instructions.

In another example, once the sensor device 300 is installed in the network, the processor 305 of the sensor device 300 can output a signal according to the first communication protocol by executing the first communication protocol computer-executable instructions. Then, if the processor 305 determines that the sensor device 300 has not established communication with the hub device for a presser period of time after outputting the signal according to the first communication protocol, the processor 305 can select the second communication protocol computer-executable instructions and execute these second communication protocol computer-executable instructions to output a signal according to the second communication protocol.

In an additional or alternative embodiment, as shown for the illustrated embodiment, the sensor device 300 can further include a protocol selection input mechanism 325. The protocol selection input mechanism 325 can be configured to receive user input selecting one of the first communication protocol and the second communication protocol for use transmitting data at the sensor device 300. The protocol selection input mechanism 325 can be in communication with the processor 305. The protocol selection input mechanism 325 can be a user-actuatable mechanism that, when actuated, causes the sensor device 300 to select one of the first or second communication protocol computer-executable instructions for use in communication in the network (e.g., with the hub device). For example, the protocol selection input mechanism 325 can be a button, switch, or other hardware mechanism configured to be actuated between a first state corresponding to selection of the first communication protocol computer-executable instructions and a second, different state corresponding to selection of the second communication protocol computer-executable instructions.

The configuration of the sensor device 300 to select one of the first or second communication protocol computer-executable instructions stored thereat can provide enhanced versatility to the sensor device 300, increase applications for use of the sensor device 300, and provide a more cost-effective sensor device. For instance, the configuration of the sensor device 300 to select one of the first or second communication protocol computer-executable instructions stored thereat can be useful in allowing the sensor device 300 to be manufactured with both the first and second communication protocol computer-executable instructions stored thereat and then subsequently allow this sensor device 300 to be deployed in either of a network having a hub device executing the first communication protocol, by the sensor device 300 selecting the first communication protocol computer-executable instructions during or after installation in the first communication protocol network, or a network having a hub device executing the second communication protocol, by the sensor device 300 selecting the second communication protocol computer-executable instructions during or after installation in the second communication protocol network.

In one example, the first type of communication protocol is a time-division duplexing protocol, such as, for example, time-division multiple access (TDMA) protocol. The TDMA protocol can be one example of a type of proprietary, manufacturer-specific communication protocol, and, in other embodiments, the first type of communication protocol can be other various types of proprietary, manufacturer-specific communication protocols. In such an example, the second, different type of communication protocol can be a non-proprietary, non-manufacturer specific communication protocol (e.g., a non-TDMA communication protocol), such as a standards-based communication protocol, for instance MATTER™ communication protocol in specific example.

As used herein, time-division duplexing can refer to processes that allocate each communication of multiple communications at a particular frequency (e.g., a 2.4 GHz band, a sub 1 GHz band) into a time “slot” of a repeating “superframe.” In contrast, frequency-division multiplexing can assign each communication of multiple communications to a unique frequency.

Processing circuitry at the hub device and sensor devices in the network can be configured to use TDMA for communication in system 10, for instance as the selected first communication protocol corresponding to the selected first communication protocol computer-executable instructions stored at the sensor device. For example, a Wi-Fi™ network of a smart home system, a BLUETOOTH network of the smart home system, and an IEEE 802.15.4 network of the smart home system may operate at a 2.4 GHz frequency (e.g., within a band of frequencies comprising 2.4 GHZ). In this example, processing circuitry, at the hub device and/or at the sensor device, may register each of the sensor devices in the network to a slot of a superframe. For example, such processing circuitry may allocate a first sensor device to a first slot of a superframe for a group of sensor devices and allocate a second sensor device to a second, different slot of that superframe for another group of sensor devices. The processing circuitry at the hub device can execute the first communication protocol to “output” the superframe by initially outputting a beacon signaling the beginning of the superframe. Each one of sensor devices executing the stored first communication protocol computer-executable instructions can synchronize with the beacon and output data according to the slots defined by the superframe. This can be repeated by the processing circuitry at the hub device periodically executing the first communication protocol so as to periodically output the superframe to allow sensor devices executing the stored first communication protocol computer-executable instructions to output sensor data to the hub device.

The hub device 12 may allocate multiple devices to a single slot of a superframe, but possibly at different portions of the single slot. For example, hub device 12 may allocate one sensor device to a first 4 ms portion of an IEEE 802.15.4 slot and allocate another sensor device to a second 4 ms portion of the IEEE 802.15.4 slot that is different from the first 4 ms portion of the IEEE 802.15.4 slot. In certain examples, hub device 12 may allocate the first sensor device to a first channel (e.g., 2.402 GHZ) of a BLUETOOTH slot and allocate the second sensor device to a second channel (e.g., 2.479 GHZ) of the BLUETOOTH slot that is different from the first channel.

The hub device 12 and the sensor device 300 can be configured to operate using a superframe. For example, sensor device 300 can output, via the communication unit 315, an enrollment signal to hub device 12, which in some cases can include an indication of a frequency band at which the sensor device 300 desires to communicate with the hub device 12. Hub device 12 can assign sensor device 300 a group number and output an indication of the group number to sensor device 300. Hub device 12 may then control a timing of communications using the superframe. For example, hub device 12 may specify a start of a superframe using a beacon and identify devices that may communicate by specifying a group assigned to the superframe. In this way, sensor device 300 (e.g., executing the stored and selected first communication protocol computer-executable instructions corresponding to the first, TDMA communication protocol) may determine when to output data. For example, sensor device 300 may, in response to a beacon output by hub device 12 indicating the group number assigned to sensor device 300, output data in accordance with the superframe. The processor 305 (e.g., via communication unit 315) may output a signal from the sensor device including data corresponding to at least one ambient condition detected by the sensor component 310.

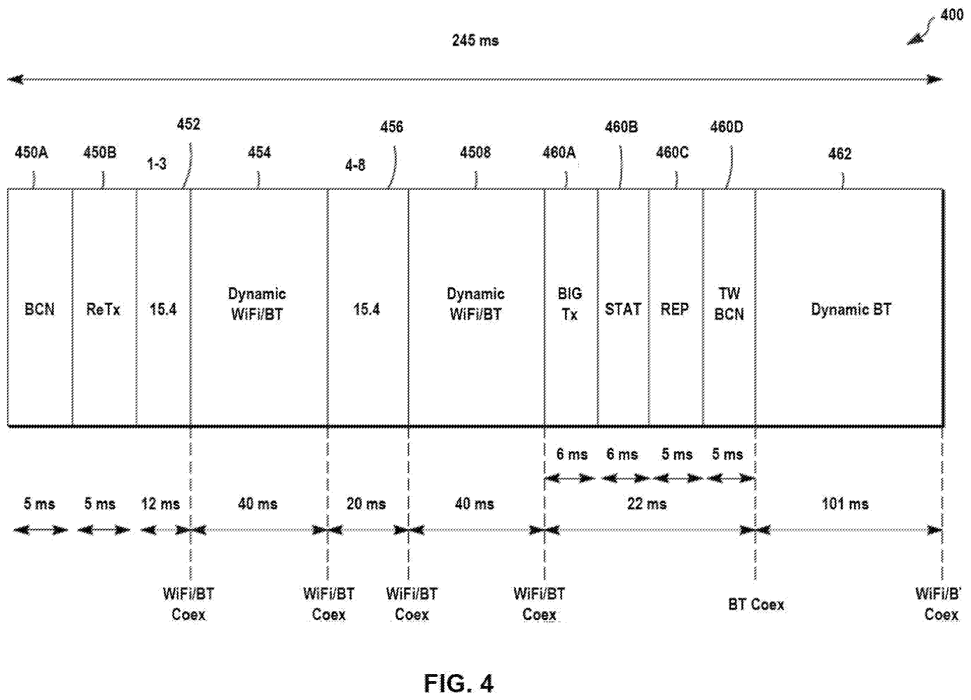

FIG. 4 illustrates a conceptual block diagram of an exemplary embodiment of slots of a single superframe 400, in accordance with some examples of this disclosure. The superframe 400 can correspond to a superframe of a first type of communication protocol, such as a type of proprietary, manufacturer-specific communication protocol, for instance TDMA where the superframe 400 can be referred to as a TDMA superframe.

As shown, the superframe 400 may include a beacon slot 450A (“BCN 450A”) and a retransmission slot 450B (“ReTx”), which may be collectively referred to here as beacon slot 450A. The order of slots shown in FIG. 4 is for example purposes only, and timing shown in FIG. 4 is for example purposes only. For example, the superframe 400 may be shorter than 245 ms or longer than 245 ms. For example, a superframe may include different slots (e.g., one or more slots may be removed and/or one or more slots may be added) and/or may include slots of different widths (e.g., different durations) than that shown for the exemplary superframe 400.

Beacon slot 450A can mark the beginning of superframe 400. Beacon slot 450A may be used by end devices (e.g., sensor device 300) to synchronize to the coordinator (e.g., hub device 12). As such, all devices in the system may synchronize to a master clock of the coordinator (e.g., hub device 12) thus forming a time synchronized networking system. Beacon slot 450A may include information that is used by the end devices to understand the system status, respond to commands, or other information, such as a frequency band at which a device (e.g., sensor device 300) will be communicating. The duration of beacon slot 450A may be 5 ms. The order of beacon slot 450A and a retransmission slot 450B shown in FIG. 4 is for example purposes only. Beacon slot A 450 may include additional or fewer slots. In some examples, the timing of beacon slot 450A may be less than 5 ms or more than 5 ms.

Retransmission slot 450B may be used for any non-enrolled (e.g., new) devices to associate with a coordinator (e.g., hub device 12) and thus become part of a personal area network (PAN), such as network system 20. Once the enrollment mode is disabled, end devices of the previous superframe group may use retransmission 450B to attempt retransmission. The duration of retransmission slot 450B may be 5 ms.

15.4 slots 452 and 456 may be used for communications compliant with IEEE 802.15.4. In an example, there may be up to 2 or 4 15.4 slots in a superframe, however, other examples may use other combinations. Each slot may include sub-slots comprising a duration of, for example, 2 ms, 4 ms, 5, ms, etc. End devices (e.g., sensor device 300) may use 15.4 slots 452 and 456 to transmit an alarm message, a status message, a Redlink™ network protocol (RNP) message, a supervision message, or other information. The total duration of each of 15.4 slot 452 and 15.4 slot 456 time segment may be, for example, 32 ms or 64 ms. The media access protocol for 15.4 slots 452 and 456 used may be TDMA. If a sensor device is not enrolled in a 15.4 slot, hub device 12 may allocated the 15.4 slots to Wi-Fi™ or BLUETOOTH.

Dynamic Wi-Fi™ BLUETOOTH slot 454 (“DYNAMIC Wi-Fi™/BT 454”) and dynamic Wi-Fi™ BLUETOOTH slot 458 (“DYNAMIC Wi-Fi™/BT 458”) may be referred to herein as a Wi-Fi™ coexistence time segments. A Wi-Fi™ time segment may be used by a Wi-Fi™ module populated on a thermostat device to transmit different types of network packets. Dynamic Wi-Fi™ BLUETOOTH slot 454, 458 may include alarm messages from the thermostat device to the central monitoring station, video streaming packets from one Wi-Fi™ client (e.g., camera or video capable sensor video/image) to another (e.g., GUI based touch screen/Cloud, etc.). The Wi-Fi™ might be operating in different modes: (a) Wi-Fi™ Client, (b) Wi-Fi™-AP, (c) Wi-Fi™-Hybrid. Wi-Fi™ slots may be dynamic, these slots may be shared to BLUETOOTH or Wi-Fi™ depending on different modes of superframes. As shown, dynamic Wi-Fi™ BLUETOOTH slot 454 and dynamic Wi-Fi™ BLUETOOTH slot 458 may be 40 ms.

Big TX/RX Slot 460A (“Big Tx 460A”), status slot 460B, repeater slot 460C (“REP 460C”), and twin beacon slot 460D (“TW BCN 460D”) may be collectively referred to herein as beacon slot B 460. The order of Big TX/RX Slot 460A, status slot 460B, repeater slot 460C, and twin beacon slot 460D shown in FIG. 4 is for example purposes only. Beacon slot B 460 may include additional or fewer slots.

Big TX/RX Slot 460A may include one or more large data transmit slots that are each more than 10 bytes and may be up to 96 bytes. An access point (e.g., hub device 12) may be able to send any data to any device using this slot. Data can be unicast, broadcast or groupcast depending on a type of request. This mode of communication may be indicated in beacon A slot 450. Big TX/RX Slot 460A may be used to send over-network download (OND) blocks to sensor devices or to set configure sensor devices. If the TX/RX Slot 460A is not active, hub device 12 may allocate time for TX/RX Slot 460A to Wi-Fi™ to increase time for Wi-Fi™ communication.

Status slot 450B may share a status with some or all of sensor devices (e.g., sensor device 300). Status slot 450B may not be active at every instance of a superframe. Status slot 450B may include data that is unicast, broadcast, or groupcast depending on a type of request. This mode of communication may be indicated in beacon A slot 450.

Repeater slot 460C may be configured for sending and receiving data from repeaters of a large/small data. An access point (e.g., hub device 12) may be able to send any data to any repeater using repeater slot 460C. Data included in repeater slot 460C can be unicast, broadcast or groupcast depending on a type of request. This mode of communication may be indicated in beacon A slot 450.

Twin beacon slot 460D may be called information beacon/twin beacon. Payload of twin beacon 460D may be almost same as beacon slot 450A with some exceptions but may operate in a different channel referred to herein as an information channel. Twin beacon slot 460D may be present in all superframes irrespective of modes of operation. Twin beacon slot 460D may be used by all the end devices to synchronize to the coordinator only if they lose connection with an access point using beacon slot 450A. Twin beacon slot 460D may not be used for synchronization of time but may be used to share the information like what is the operation channel or frequency hopping sequence or a next channel of communication. The duration of twin beacon slot 460D may be 5 ms. In some examples, the timing of twin beacon slot 460D may be less than 5 ms or more than 5 ms.

Dynamic BLUETOOTH slot 462 may be dedicated to BLUETOOTH by an access Point (e.g., hub device 12). Dynamic BLUETOOTH slot 462 may support mobile and sensor communication. Allocation of dynamic BLUETOOTH slot 462 may vary with different modes of comfort/security superframes as described further below. As shown, dynamic BLUETOOTH slot 462 may be 101 ms. In some examples, the timing of dynamic BLUETOOTH slot 462 may be less than 101 ms or more than 101 ms.

As noted, when the first communication protocol is a type of proprietary, manufacturer-specific communication protocol, for instance TDMA, such as TDMA with the illustrated TDMA superframe, the second communication protocol can be a non-proprietary, non-manufacturer-specific communication protocol (e.g., a non-TDMA communication protocol), such as a standards-based communication protocol, for instance MATTER™ communication protocol. Thus, depending on whether the sensor device 300 selects the first communication protocol computer-executable instructions, corresponding to the first communication protocol, or the second communication protocol computer-executable instructions, corresponding to the second communication protocol, the sensor device 300 can be configured to be in signal communication in the network via a type of proprietary, manufacturer-specific communication protocol or a type of non-proprietary, non-manufacturer-specific, standards-based communication protocol.

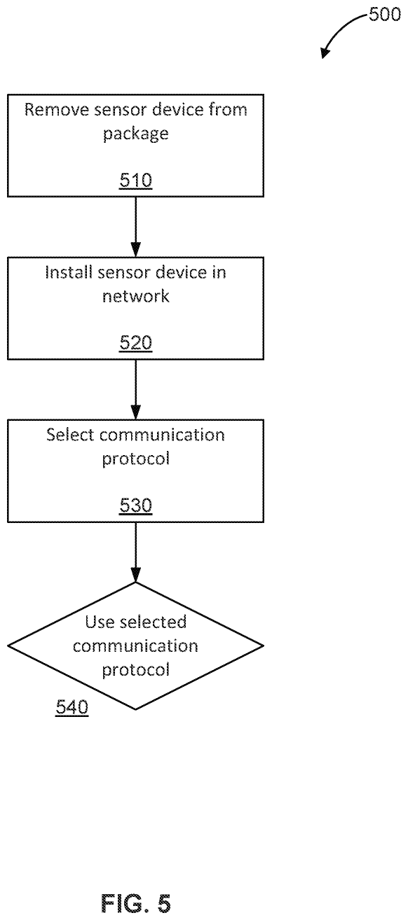

FIG. 5 is a flow diagram on an exemplary method 500. The method 500 can be performed using any one or more of the features disclosed and/or illustrated in this disclose. For example, in one embodiment, the method 500 can be performed, in whole or in part, using the sensor device 300 described herein.

At step 510, the method 500 includes removing a sensor device from a package. For example, the sensor device can be the sensor device 300 removed from the package 330. When the sensor device is in the package, the sensor device can include a programmable processor, a sensor component configured to detect at least one ambient condition, a transmitter configured to transmit data relating to the at least one ambient condition, and a non-transitory computer-readable storage article. The sensor component and the transmitter can be in communication with the programmable processor. When the sensor device is in the package, the non-transitory computer-readable storage article of the sensor device can include both a first communication protocol computer-executable instructions and a second communication protocol computer-executable instructions. When the first communication protocol computer-executable instructions is executed by the programmable processor, the first communication protocol computer-executable instructions can cause the programmable processor to transmit data, via the transmitter, according to a first communication protocol. When the second communication protocol computer-executable instructions is executed by the programmable processor, the second communication protocol computer-executable instructions can cause the programmable processor to transmit data, via the transmitter, according to a second communication protocol.

The second communication protocol can be different than the first communication protocol. For example, the first communication protocol can be a type of proprietary, manufacturer-specific communication protocol, for instance TDMA. And, the second communication protocol can be a non-proprietary, non-manufacturer-specific communication protocol (e.g., a non-TDMA communication protocol), such as a standards-based communication protocol, for instance MATTER™ communication protocol. It can be the case that only one of the first communication protocol and the second communication protocol utilizes TDMA. In some examples, the first communication protocol and the second communication protocol can utilize a same frequency band for communication in the network. For instance, the same frequency band can be 2.4 GHz.

In some embodiments, when the sensor device is in the package, the first communication protocol computer-executable instructions and the second communication protocol computer-executable instructions can occupy an amount of memory capacity of the non-transitory computer-readable storage article at the sensor device such that the non-transitory computer-readable storage article at the sensor device lacks additional memory capacity to store a firmware download in addition to the first communication protocol computer-executable instructions and the second communication protocol computer-executable instructions at the non-transitory computer-readable storage article at the sensor device.

In some cases, the sensor device utilized in performance of the method 500 can include the non-transitory computer-readable storage article as a single memory component. And, when this is the case, the single memory component can include each of the first communication protocol computer-executable instructions and the second communication protocol computer-executable instructions.

At step 520, the method 500 includes installing the sensor device in a premise network. The sensor device can be installed in the premise network at step 520 after removing the sensor device from the package at step 510. The sensor device can be installed in a premise network, such as that illustrated and/or described in reference to FIG. 1.

At step 530, the method 500 includes selecting, from the non-transitory computer-readable storage article at the sensor device, one of the first communication protocol computer-executable instructions and the second communication protocol computer-executable instructions.

In some embodiments, the method 500 can further include, after selecting one of the first communication protocol computer-executable instructions and the second communication protocol computer-executable instructions at step 530, removing the other, non-selected of the first communication protocol computer-executable instructions and the second communication protocol computer-executable instructions from the non-transitory computer-readable storage article at the sensor device. For instance, after selecting one of the first communication protocol computer-executable instructions and the second communication protocol computer-executable instructions at step 530, the method 500 can include receiving, at the sensor device, a firmware download and overwriting the other, non-selected of the first communication protocol computer-executable instructions and the second communication protocol computer-executable instructions in the non-transitory computer-readable storage article at the sensor device.

In some cases, the method 500 can include receiving a signal at the sensor device and using this signal to select the communication protocol. As one such example, the method 500 can include receiving, via the premise network at the sensor device from a hub, a signal including information relating to a type of protocol utilized in the premise network. The one of the first communication protocol computer-executable instructions and the second communication protocol computer-executable instructions can be selected after installing the sensor device in the premise network and based on the type of protocol utilized in the premise network.

At step 540, the method 500 includes using the selected one of the first communication protocol computer-executable instructions and the second communication protocol computer-executable instructions to transmit data, via the premise network, relating to the at least one ambient condition.

It is to be recognized that depending on the example, certain acts or events of any of the techniques described herein can be performed in a different sequence, may be added, merged, or left out altogether (e.g., not all described acts or events are necessary for the practice of the techniques). Moreover, in certain examples, acts or events may be performed concurrently, e.g., through multi-threaded processing, interrupt processing, or multiple processors, rather than sequentially.

In one or more examples, the functions described may be implemented in hardware, software, firmware, or any combination thereof. If implemented in software, the functions may be stored on or transmitted over as one or more instructions or code on a computer-readable medium and executed by a hardware-based processing unit. Computer-readable media may include computer-readable storage media, which corresponds to a tangible medium such as data storage media, or communication media including any medium that facilitates transfer of a computer program from one place to another, e.g., according to a communication protocol. In this manner, computer-readable media generally may correspond to (1) tangible computer-readable storage media which is non-transitory or (2) a communication medium such as a signal or carrier wave. Data storage media may be any available media that can be accessed by one or more computers or one or more processors to retrieve instructions, code and/or data structures for implementation of the techniques described in this disclosure. A computer program product may include a computer-readable medium.

By way of example, and not limitation, such computer-readable storage media can comprise RAM, ROM, EEPROM, CD-ROM or other optical disk storage, magnetic disk storage, or other magnetic storage devices, flash memory, or any other medium that can be used to store desired program code in the form of instructions or data structures and that can be accessed by a computer. Also, any connection is properly termed a computer-readable medium. For example, if instructions are transmitted from a website, server, or other remote source using a coaxial cable, fiber optic cable, twisted pair, digital subscriber line (DSL), or wireless technologies such as infrared, radio, and microwave, then the coaxial cable, fiber optic cable, twisted pair, DSL, or wireless technologies such as infrared, radio, and microwave are included in the definition of medium. It should be understood, however, that computer-readable storage media and data storage media do not include connections, carrier waves, signals, or other transitory media, but are instead directed to non-transitory, tangible storage media. Disk and disc, as used herein, includes compact disc (CD), laser disc, optical disc, digital versatile disc (DVD), floppy disk and Blu-ray disc, where disks usually reproduce data magnetically, while discs reproduce data optically with lasers. Combinations of the above should also be included within the scope of computer-readable media.

Instructions may be executed by one or more processors, such as one or more digital signal processors (DSPs), general purpose microprocessors, application specific integrated circuits (ASICs), field programmable logic arrays (FPGAs), or other equivalent integrated or discrete logic circuitry. Accordingly, the term “processor,” as used herein may refer to any of the foregoing structure or any other structure suitable for implementation of the techniques described herein. In addition, in some aspects, the functionality described herein may be provided within dedicated hardware and/or software modules configured for encoding and decoding, or incorporated in a combined codec. Also, the techniques could be fully implemented in one or more circuits or logic elements.

The techniques of this disclosure may be implemented in a wide variety of devices or apparatuses, including a wireless handset, an integrated circuit (IC) or a set of ICs (e.g., a chip set). Various components, modules, or units are described in this disclosure to emphasize functional aspects of devices configured to perform the disclosed techniques, but do not necessarily require realization by different hardware units. Rather, as described above, various units may be combined in a codec hardware unit or provided by a collection of interoperative hardware units, including one or more processors as described above, in conjunction with suitable software and/or firmware.

Various examples of the disclosure have been described. Any combination of the described systems, operations, or functions is contemplated. These and other examples are within the scope of the following claims.

What is claimed is:

1. A sensor device comprising:
a programmable processor;
a sensor component configured to detect at least one ambient condition, the sensor component in communication with the programmable processor;
a transmitter configured to transmit data relating to the at least one ambient condition, the transmitter in communication with the programmable processor; and
a non-transitory computer-readable storage article comprising:
a first communication protocol computer-executable instructions that, when executed by the programmable processor, cause the programmable processor to transmit data, via the transmitter, according to a first communication protocol, and
a second communication protocol computer-executable instructions that, when executed by the programmable processor, cause the programmable processor to transmit data, via the transmitter, according to a second communication protocol, the second communication protocol being different than the first communication protocol,
wherein the first communication protocol computer-executable instructions and the second communication protocol computer-executable instructions occupy an amount of memory capacity of the non-transitory computer-readable storage article such that the non-transitory computer-readable storage article lacks additional memory capacity to store a firmware download in addition to the first communication protocol computer-executable instructions and the second communication protocol computer-executable instructions.

2. The sensor device of claim 1, wherein the first communication protocol and the second communication protocol utilize a same frequency band.

3. The sensor device of claim 1, wherein the first communication protocol and the second communication protocol utilize different frequency bands.

4. The sensor device of claim 1, wherein only one of the first communication protocol and the second communication protocol utilizes time divisional multiple access (TDMA).

5. The sensor device of claim 1, wherein the programmable processor is configured to select one of the first communication protocol computer-executable instructions and the second communication protocol computer-executable instructions for use in transmitting data relating to the at least one ambient condition.

6. The sensor device of claim 5, wherein after the programmable processor has selected one of the first communication protocol computer-executable instructions and the second communication protocol computer-executable instructions for use in transmitting data relating to the at least one ambient condition, the sensor device is configured to overwrite the other of the first communication protocol computer-executable instructions and the second communication protocol computer-executable instructions in the non-transitory computer-readable storage article with a firmware download received at the sensor device.

7. The sensor device of claim 5, further comprising:
a protocol selection input mechanism configured to receive user input selecting one of the first communication protocol and the second communication protocol for use transmitting data, the protocol selection input mechanism in communication with the programmable processor.

8. The sensor device of claim 5, wherein the programmable processor is configured to select one of the first communication protocol computer-executable instructions and the second communication protocol computer-executable instructions for use in transmitting data based on a signal received at the sensor device.

9. The sensor device of claim 8, wherein the signal received at the sensor device includes information relating to a type of protocol utilized in a network, and wherein the programmable processor is configured to select one of the first communication protocol computer-executable instructions and the second communication protocol computer-executable instructions for use in transmitting data based on the type of protocol utilized in the network.

10. The sensor device of claim 1, wherein the non-transitory computer-readable storage article includes the first communication protocol computer-executable instructions and the second communication protocol computer-executable instructions at a time when the sensor device is manufactured.

11. The sensor device of claim 1, wherein the non-transitory computer-readable storage article is a single memory component, and wherein the single memory component includes each of the first communication protocol computer-executable instructions and the second communication protocol computer-executable instructions.

12. The sensor device of claim 1, wherein the sensor component is selected from the group consisting of: a motion detector, a glass break detector, a door open detector, a window open detector, a smoke detector, and a gas detector.

13. A method comprising the steps of:
removing a sensor device from a package, wherein when the sensor device is in the package the sensor device comprises:
a programmable processor,
a sensor component configured to detect at least one ambient condition, the sensor component in communication with the programmable processor,
a transmitter configured to transmit data relating to the at least one ambient condition, the transmitter in communication with the programmable processor, and
a non-transitory computer-readable storage article comprising:
a first communication protocol computer-executable instructions that, when executed by the programmable processor, cause the programmable processor to transmit data, via the transmitter, according to a first communication protocol, and
a second communication protocol computer-executable instructions that, when executed by the programmable processor, cause the programmable processor to transmit data, via the trans-mitter, according to a second communication protocol, the second communication protocol being different than the first communication protocol:
installing the sensor device in a premise network;
selecting, from the non-transitory computer-readable storage article at the sensor device, one of the first communication protocol computer-executable instructions and the second communication protocol computer-executable instructions; and
using the selected one of the first communication protocol computer-executable instructions and the second communication protocol computer-executable instructions to transmit data, via the premise network, relating to the at least one ambient condition.

14. The method of claim 13, wherein, when the sensor device is in the package, the first communication protocol computer-executable instructions and the second communication protocol computer-executable instructions occupy an amount of memory capacity of the non-transitory computer-readable storage article such that the non-transitory computer-readable storage article lacks additional memory capacity to store a firmware download in addition to the first communication protocol computer-executable instructions and the second communication protocol computer-executable instructions.

15. The method of claim 13, wherein the first communication protocol and the second communication protocol utilize a same frequency band.

16. The method of claim 15, wherein the same frequency band is 2.4 GHz.

17. The method of claim 13, wherein only one of the first communication protocol and the second communication protocol utilizes time divisional multiple access (TDMA).

18. The method of claim 13, further comprising:
after selecting one of the first communication protocol computer-executable instructions and the second communication protocol computer-executable instructions, receiving, at the sensor device, a firmware download and overwriting the other of the first communication protocol computer-executable instructions and the second communication protocol computer-executable instructions in the non-transitory computer-readable storage article.

19. The method of claim 13, wherein the non-transitory computer-readable storage article is a single memory component, and wherein the single memory component includes each of the first communication protocol computer-executable instructions and the second communication protocol computer-executable instructions.

20. The method of claim 13, further comprising:
receiving, via the premise network at the sensor device from a hub device, a signal including information relating to a type of protocol utilized in the premise network,
wherein the one of the first communication protocol computer-executable instructions and the second communication protocol computer-executable instructions is selected after installing the sensor device in the premise network and based on the type of protocol utilized in the premise network.
